(19) United States
(12) Patent Application Publication
(10) Pub. No.: US 2010/0306235 A1
(43) Pub. Date: Dec. 2, 2010

(54) Real-Time Detection of Emerging Web Search Queries

(75) Inventor: Gilad Avraham Mishne, Oakland, CA (US)

Correspondence Address: BAKER BOTTS L.L.P., 2001 ROSS AVENUE, 6TH FLOOR, DALLAS, TX, 75201, US

(73) Assignee: Yahoo! Inc., Sunnyvale, CA (US)

(21) Appl. No.: 12/474,031

(22) Filed: May 28, 2009

(51) Int. Cl. G06F 17/30; G06N 7/02

(52) U.S. Cl. 707/769; 706/52; 703/13; 707/770; 707/708

(57) ABSTRACT

A current query model is constructed representing a first histogram of a first set of counts corresponding to a first set of search queries and a current time interval. One or more historical query models are constructed, each uniquely representing a different second histogram of a different second set of counts corresponding to a different second set of search queries and a different historical time interval. A third search query is received. A first generation probability is calculated for the third search query with respect to the current query model. One or more second generation probabilities are calculated for the third search query with respect to the historical query models. A ratio is calculated based on the first generation probability and the second generation probabilities. The third search query is identified as corresponding to an emerging event if the ratio satisfies a predetermined threshold requirement.

### TECHNICAL FIELD

The present disclosure generally relates to automatically detecting in real-time “emerging” search queries, i.e., those search queries relating to recently occurred events.

### BACKGROUND

The Internet provides access to a vast amount of information. The information is stored at many different sites, e.g., on computers and servers and in databases, around the world. These different sites are communicatively linked to the Internet via various network infrastructures. People, i.e., Internet users, may access the publicly available information on the Internet via various suitable network devices connected to the Internet, such as, for example, computers and telecommunication devices.

Due to the sheer amount of information available on the Internet, it is impractical as well as impossible for an Internet user to manually search throughout the Internet for specific pieces of information. Instead, most Internet users rely on different types of computer-implemented tools to help them locate the desired information. One of the most convenient and widely used tools is a search engine, such as the search engines provided by Yahoo! ® Inc. (http://search.yahoo.com), Google™ (http://www.google.com), and Microsoft® Inc. (http://search.live.com).

To search for the information relating to a specific topic or subject matter, an Internet user provides a short phrase consisting of one or more words, often referred to as a “search query”, to a search engine. The search query typically describes the topic or subject matter. The search engine conducts a search based on the search query using various search algorithms and generates a search result that identifies one or more contents most likely to be related to the topic or subject matter described by the search query. contents are data or information available on the Internet and may be in various formats, such as texts, audios, videos, graphics, etc. The search result is then presented to the user requesting the search, often in the form of a list of clickable links, each link being associated with a different web page containing some of the contents identified in the search result. The user then is able to click on the individual links to view the specific contents as he wishes.

There are continuous efforts to improve the performance qualities of the search engines. Accuracy, completeness, presentation order, and speed are but a few aspects of the search engines for improvement.

### SUMMARY

The present disclosure generally relates to automatically detecting in real-time emerging search queries.

In particular embodiments, emerging search queries, i.e., search queries relating to topics, subject matters, or events that occurred recently, are detected based comparisons between the generation likelihood of the emerging search queries with respect to a current time interval and the generation likelihood of the emerging search queries with respect to each of one or more historical time intervals. The historical time intervals may be considered as references for the purpose of comparing the generation likelihoods.

In particular embodiments, a current query model is constructed representing a first histogram of a first set of counts corresponding to a first set of search queries received at a search engine during a current time interval; one or more historical query models are constructed, each of the historical query models uniquely representing a different one of one or more second histograms of a different one of one or more second sets of counts corresponding to a different one of one or more second sets of search queries received at the search engine during a different one of one or more historical time intervals; a third search query is received at the search engine; a first generation probability is calculated for the third search query with respect to the current query model, the first generation probability representing a likelihood that the third search query is generated from the first set of search queries as represented in the current query model; one or more second generation probabilities are calculated for the third search query with respect to the historical query models, each of the second generation probabilities being uniquely calculated with respect to a different one of the historical query models and representing a likelihood that the third search query is generated from the corresponding second set of search queries as represented in the corresponding historical query model; a ratio is calculated based on the first generation probability and the second generation probabilities; and the third search query is identified as corresponding to an emerging event if the ratio satisfies a predetermined threshold requirement.

These and other features, aspects, and advantages of the disclosure are described in more detail below in the detailed description and in conjunction with the following figures.

### BRIEF DESCRIPTION OF THE DRAWINGS

The present disclosure is illustrated by way of example, and not by way of limitation, in the figures of the accompanying drawings and in which like reference numerals refer to similar elements and in which:

FIG. 1 illustrates an example system for automatically detecting emerging search queries in real-time.

FIG. 2 illustrates an example method for automatically detecting emerging search queries in real-time.

FIG. 3 illustrates an example timeline.

FIG. 4 illustrates an example computer system.

### DETAILED DESCRIPTION OF EXEMPLARY EMBODIMENTS

The present disclosure is now described in detail with reference to a few exemplary embodiments thereof as illustrated in the accompanying drawings. In the following description, numerous specific details are set forth in order to provide a thorough understanding of the present disclosure. It is apparent, however, to one skilled in the art, that the present disclosure may be practiced without some or all of these specific details. In other instances, well known process steps or structures have not been described in detail in order to not unnecessarily obscure the present disclosure. In addition, while the disclosure is described in conjunction with the particular embodiments, it should be understood that this description is not intended to limit the disclosure to the described embodiments. To the contrary, the description is intended to cover alternatives, modifications, and equivalents as may be included within the spirit and scope of the disclosure as defined by the appended claims.

Search engines help Internet users locate specific contents, i.e., data or information available on the Internet, from the vast amount of contents publicly available on the Internet. In a typical scenario, to locate contents relating to a specific topic or subject matter, an Internet user requests a search from a search engine by providing a search query to the search engine. The search query generally contains one or more words that describe the subject matter or the type of content or information the user is looking for on the Internet.

The search engine conducts the search based on the search query using various search algorithms employed by the search engine and generates a search result that identifies one or more specific contents that are most likely to be related to the search query. The contents identified in the search result are presented to the user, often as clickable links to various web pages located at various websites, each of the web pages containing some of the identified contents.

In addition to merely locating and identifying the specific contents relating to the individual search queries, the search engines often provide additional information that may be helpful to the users requesting the searches. For example, a search result generated in response to a search query most likely identifies multiple contents. A search engine may employ a ranking algorithm to rank the contents identified in a search result according to their degrees of relevance to the corresponding search query. Those contents that are relatively more relevant to the corresponding search query are ranked higher and presented to the user requesting the search before those contents that are relatively less relevant to the corresponding search query. In addition, the search engine may employ a summarization algorithm to summarize each of the contents identified in the search result so that each content is presented to the user along with a short summary that helps the user determine which content may be more interesting and worth further viewing.

There are continuous efforts to improve the performance qualities of the search engines. In particular embodiments, it may be desirable for a search engine to be able to detect in real-time search queries relating to “emerging” events, i.e., events that occur recently, such as breaking news occurred within the past few hours, or events that are on-going. A search query relating to an emerging event may be referred to as an “emerging search query”. For example, suppose that an earthquake has just occurred in Northern California. Within minutes of the earthquake, news agencies and individuals may begin posting reports, news articles, photographs, or videos of the earthquake on the Internet. As more and more people hear about the earthquake from various sources, Internet users may begin searching for information about the earthquake on the Internet. To do so, they may provide search queries such as “earthquake”, “California earthquake”, or “earthquake in Northern California” to the search engines. In this case, the earthquake in Northern California is a particular emerging event, and the various search queries relating to the earthquake, i.e., “earthquake”, “California earthquake”, or “earthquake in Northern California”, are the emerging search queries relating to the particular emerging event.

Of course, while some Internet users are searching for information about the California earthquake on the Internet, other Internet users may still search for other information completely unrelated to the earthquake, i.e., the emerging event, on the Internet. For example, a student working on a school paper on the history of the American Civil War may provide search queries relating to the Civil War, such as “American Civil War”, “President Abraham Lincoln”, “Robert E. Lee”, or “the Battle of Gettysburg”, to a search engine.

In particular embodiments, a search engine may treat emerging search queries relating to emerging events differently from search queries relating to other types of information due to the time-sensitive nature of the emerging events. For example, specialized links to relevant news stories may be included in the search results generated in response to the emerging search queries. Additional information such as last-modified time may be provided with the contents identified in the search results generated in response to the emerging search queries so that the users may determine whether the individual contents contain the most current information. Different ranking algorithms may be used to rank the contents identified in the search results generated in response to the emerging search queries, taking into consideration, for example, the relative currentness as well as relevancy of the individual contents with respect to the corresponding emerging search queries.

In order to provide special services for the emerging search queries, a search engine needs to distinguish emerging search queries from other types of search queries, preferably in real-time. To detect emerging search queries in real-time, in particular embodiments, a current query model and one or more historical query models are constructed based on network traffic data monitored and collected at a search engine. In particular embodiments, the current query model represents a histogram of the different search queries received at the search engine during a recent time interval, e.g., within the most-recent few hours. Each of the historical query models represents a histogram of the different search queries received at the search engine during a different historical time interval.

Upon receiving a new search query at the search engine, a different generation probability is calculated for the new search query with respect to the current query model and each of the historical query models. In general, a generation probability for a search query with respect to a query model indicates the likelihood or probability that the search query may be constructed or generated from the segments, i.e., words, found in the search queries represented in the query model.

In particular embodiments, a ratio is calculated based on the generation probabilities corresponding to the current query model and the historical query models. If the ratio satisfies a predefined threshold requirement, then the new search query is considered an emerging search query. The ratio also indicates the confidence level that the new search query is an emerging search query.

In particular embodiments, in addition to the current query model and the historical query models, a current content model and one or more historical content models are constructed based on collected content information. The current content model represents a histogram of the individual contents emerged on the Internet during the recent time interval. Each of the historical content models represents a histogram of the individual contents emerged on the Internet during one of the historical time intervals. In particular embodiments, a particular content is identified by its title in the histogram.

Upon receiving the new search query at the search engine, a different generation probability is calculated for the new search query with respect to the current query model and each of the historical query models as well as the current content model and each of the historical content models. In general, a generation probability for a search query with respect to a content model indicates the likelihood or probability that the search query may be constructed or generated from the segments, i.e., words, found in the content titles represented in the query model.

The ratio is then calculated based on the generation probabilities corresponding to the current query model, the historical query models, the current content model, and the historical content models. In particular embodiments, the ratio is calculated based on the ratios between the generation probability corresponding to the current query model and the generation probability corresponding to each of the historical query models, and optionally further based on the ratios between the generation probability corresponding to the current content model and the generation probability corresponding to each of the historical content models. If the ratio satisfies a predefined threshold requirement, then the new search query is considered an emerging search query. Again, the ratio also indicates the confidence level that the new search query is an emerging search query.

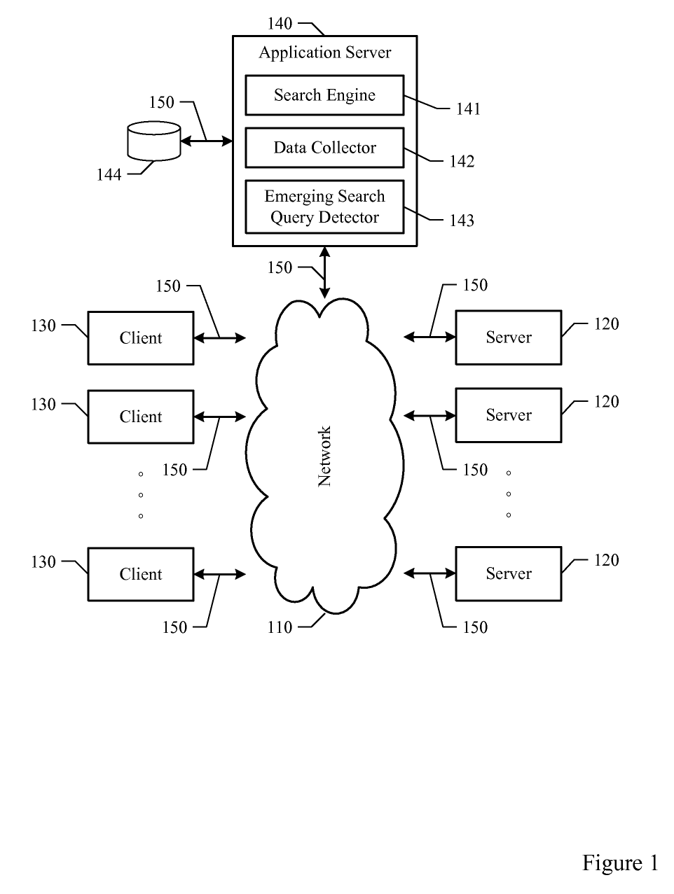

FIG. 1 illustrates an example system 100 for automatically detecting emerging search queries in real-time. System 100 includes a network 110 coupling one or more servers 120, one or more clients 130, and an application server 140 to each other. In particular embodiments, network 110 is an intranet, an extranet, a virtual private network (VPN), a local area network (LAN), a wireless LAN (WLAN), a wide area network (WAN), a metropolitan area network (MAN), a portion of the Internet, or another network 110 or a combination of two or more such networks 110. The present disclosure contemplates any suitable network 110.

One or more links 150 couple a server 120, a client 130, or application server 140 to network 110. In particular embodiments, one or more links 150 each includes one or more wired, wireless, or optical links 150. In particular embodiments, one or more links 150 each includes an intranet, an extranet, a VPN, a LAN, a WLAN, a WAN, a MAN, a portion of the Internet, or another link 150 or a combination of two or more such links 150. The present disclosure contemplates any suitable links 150 coupling servers 120, clients 130, and application server 140 to network 110.

In particular embodiments, each server 120 may be a unitary server or may be a distributed server spanning multiple computers or multiple datacenters. Servers 120 may be of various types, such as, for example and not by way of limitation, web server, news server, mail server, message server, advertising server, file server, application server, exchange server, database server, or proxy server. In particular embodiments, each server 120 includes hardware, software, or embedded logic components or a combination of two or more such components for carrying out the appropriate functionalities implemented or supported by server 120. For example, a web server is generally capable of hosting websites containing web pages or particular elements of web pages. More specifically, a web server may host HTML files or other file types, or may dynamically create or constitute files upon a request, and communicate them to clients 130 in response to HTTP or other requests from clients 130. A mail server is generally capable of providing electronic mail services.

In particular embodiments, a client 130 enables a user at client 130 to access network 110. As an example and not by way of limitation, a client 130 may be a desktop computer system, a notebook computer system, a netbook computer system, or a mobile telephone having a web browser, such as Microsoft Internet Explore, or Mozilla Firefox, which, for example, may have one or more add-ons, plug-ins, or other extensions, such as Google Toolbar or Yahoo Toolbar. The present disclosure contemplates any suitable clients 130.

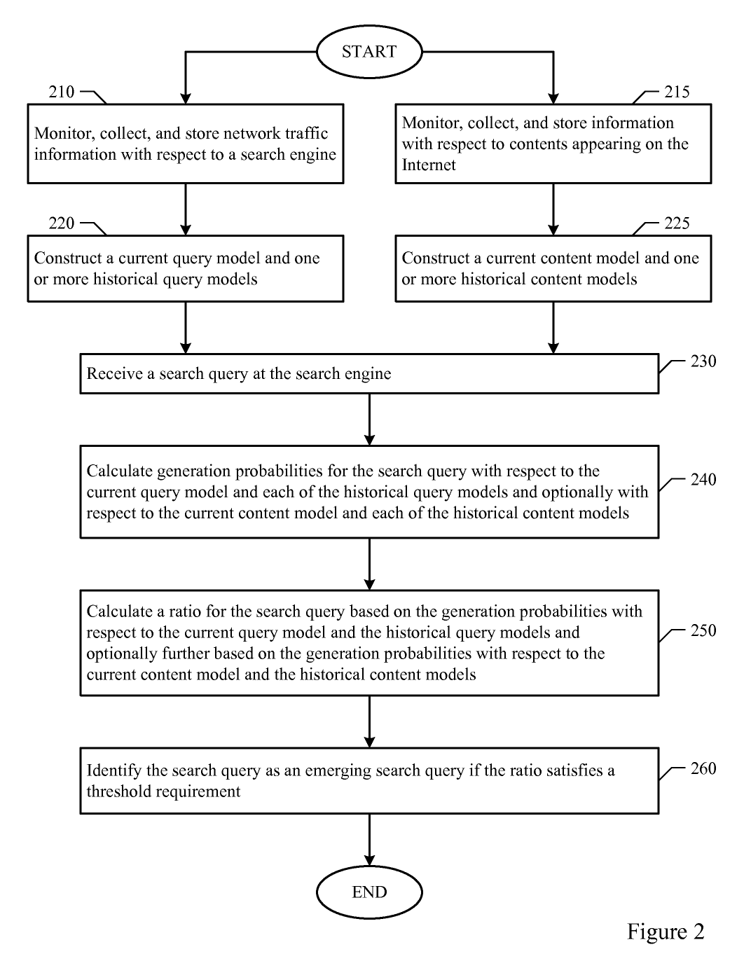

In particular embodiments, application server 140 includes one or more computer servers or other computer systems, either centrally located or distributed among multiple locations. In particular embodiments, application server 140 includes hardware, software, or embedded logic components or a combination of two or more such components for carrying out various appropriate functionalities. Some of the functionalities performed by application server 140 are described in more detail below with reference to FIG. 2.

In particular embodiments, application server 140 includes a search engine 141. In particular embodiments, search engine 141 includes hardware, software, or embedded logic component or a combination of two or more such components for generating and returning search results identifying contents responsive to search queries received from clients 130. The present disclosure contemplates any suitable search engine 141. As an example and not by way of limitation, search engine 141 may be Altavista™, Baidu, Google, Microsoft Live Search, or Yahoo!® Search. In particular embodiments, search engine 141 may implement various search, ranking, and summarization algorithms. The search algorithms may be used to locate specific contents for specific search queries. The ranking algorithms may be used to rank a set of contents located for a particular search query. The summarization algorithms may be used to summarize individual contents.

In particular embodiments, application server 140 includes a data collector 142. In particular embodiments, data collector 142 includes hardware, software, or embedded logic component or a combination of two or more such components for monitoring and collecting network traffic data at search engine 141. In particular embodiments, the network traffic data collected include at least the search queries and the time each of the search queries is received at search engine 141. In addition, the network traffic data collected may also include, for example, the search results generated by search engine 141 in response to the search queries. A data storage 160 is communicatively linked to application sever 140 via a link 150 and may be used to store the collected network traffic data at search engine 141 for further analysis.

In particular embodiments, application server 140 includes an emerging search query detector 143. In particular embodiments, emerging search query detector 143 includes hardware, software, or an embedded logic component or a combination of two or more such components for automatically detecting emerging search queries among the search queries received at search engine 141 in real-time. In particular embodiments, emerging search query detector 143 constructs a current query model and one or more historical query models based on the network traffic data collected by data collector 142 and stored in data storage 144. The current and historical query models may be continuously updated as new network traffic data are collected. Optionally, emerging search query detector 143 may construct, in addition to the query models, a current content model and one or more historical content models based on the Internet data obtained from servers 120. As a new search query is received at search engine 141, emerging search query detector 143 may determine whether the new search query is an emerging search query using the current and historical query models and optionally the current content model and the historical content models.

FIG. 2 illustrates an example method for automatically detecting emerging search queries in real-time. In particular embodiments, the steps of the process illustrated in FIG. 2 may be implemented as computer software and executed on application server 140. In particular embodiments, network traffic information with respect to a search engine is continuously monitored, collected, and stored (step 210). The information may indicate, among others, the specific search queries and the time each of the search queries is received at the search engine.

Based on the network traffic information, a current query model and one or more historical query models may be constructed (step 220). The current query model represents a histogram of the search queries received at the search engine during a current time interval. Each of the historical query models represents a different histogram of the search queries received at the search engine during a different historical time interval.

The search engine often receives many search queries during a particular time interval. A search query may contain one or more words. In general, a histogram represents the total number of times, i.e., the count, each individual search query is received at the search engine during a particular time interval. For example, suppose that during the time interval between 10:00 and 11:00 on May 6, 2009, three search queries, “myspace”, “facebook”, and “ebay”, are received at a search engine. Further suppose that search query “myspace” is received at the search engine for a total of 5000 times, search query “facebook” is received at the search engine for a total of 4500 times, and search query “ebay” is received at the search engine for a total of 3500 times. The histogram representing the search queries received during 10:00 and 11:00 on May 6, 2009 thus includes [myspace, 5000], [facebook, 4500], and [ebay, 3500]. As this example indicates, a histogram representing the search queries received at a search engine may be expressed as one or more 2-tuples consisting of [search query, count]. The following Table 1 illustrates an example set of search queries and the number of times each search query is received at a search engine during a particular time interval.

TABLE 1
Example Search Queries and Their Counts

| Search Queries | Counts |
|---|---|
| myspace | 5000 |
| facebook | 4500 |
| ebay | 3600 |
| youtube | 3000 |
| hotmail | 800 |
| gmail | 675 |
| msn | 350 |
| sports | 30 |
| Texas education agency | 1 |

In particular embodiments, the current query model represents a histogram of the different search queries received at the search engine during a current time interval. In particular embodiments, the current time interval is selected with respect to a current time. The actual length of the current time interval may be user-determined or determined based on experimental or empirical data. For example, the current time interval may be selected as the most-recent three hours, the most-recent twelve hours, the most-recent twenty-four hours, or the current day. For example, if the current time is 13:00 on May 6, 2009, then the most-recent three hours is between 10:00 and 13:00 on May 6, 2009. However, if the current time is 13:30, then the most-recent three hours is between 10:30 and 13:30. Thus, the current time interval continuously changes in the actual time period, e.g., the specific hours, minutes, or seconds, it covers as time goes by, even though the length of the current time interval may remain unchanged.

The current query model may include, for each search query received at the search engine during the current time interval, the total number of times that search query is received during the current time interval. In particular embodiments, since the network traffic information monitored for the search engine includes the specific search queries and the timestamps of the search queries received at the search engine, the network traffic information may be used to determine which search queries are received at the search engine during the current time interval and how many times.

Each of the historical query models represents a different histogram of the different search queries received at the search engine during a different historical time interval. In particular embodiments, a historical time interval is a time interval from some time in the past. The actual length of a historical time interval may be user-determined or determined based on experimental or empirical data, and two historical time intervals may have same or different lengths. Although not required, in particular embodiments, some or all of the historical time intervals may be related to the current time interval, such as the same hours during a previous day, a previous week, a previous month, a previous year, etc. For example, if the current time interval is between 10:00 and 13:00 on May 6, 2009, one historical time interval may be between 10:00 and 13:00 on May 5, 2009 (the same hours during a previous day), a second historical time interval may be between 10:00 and 13:00 on Apr. 29, 2009 (the same hours on the same day during a previous week), a third historical time interval may be between 10:00 and 13:00 on Apr. 6, 2009 (the same hours on the same day during a previous month), and so on.

In particular embodiments, since recent historical information may be more relevant than distant historical information, a greater number of historical query models may be constructed for relatively recent historical time intervals and a fewer number of historical query models may be constructed for relatively distant historical time intervals. For example, if the current time interval is between 10:00 and 13:00 on May 6, 2009, a different historical query model may be constructed for the time interval between 10:00 and 13:00 for each day of the week during the most-recent week, e.g., from Apr. 29, 2009 to May 5, 2009. For the most-recent month, one day out of each week may be selected such that a different historical query model is constructed for the time interval between 10:00 and 13:00 for one day out of each week during the most-recent month, e.g., Apr. 1, 2009, Apr. 8, 2009, Apr. 15, 2009, Apr. 22, 2009, and Apr. 29, 2009. For the most-recent year, one day out of each month may be selected such that a different historical query model is constructed for the time interval between 10:00 and 13:00 for one day out of each month during the most-recent month, e.g., Apr. 6, 2009, Mar. 6, 2009, Feb. 6, 2009, Jan. 6, 2009, and so on.

Each historical query model may include, for each search query received at the search engine during a particular historical time interval, the total number of times that search query is received during the historical time interval. In particular embodiments, again, since the network traffic information monitored for the search engine includes the specific search queries received at the search engine and the time the search queries are received at the search engine, the network traffic information may be used to determine which search queries are received at the search engine during the particular time interval and how many times.

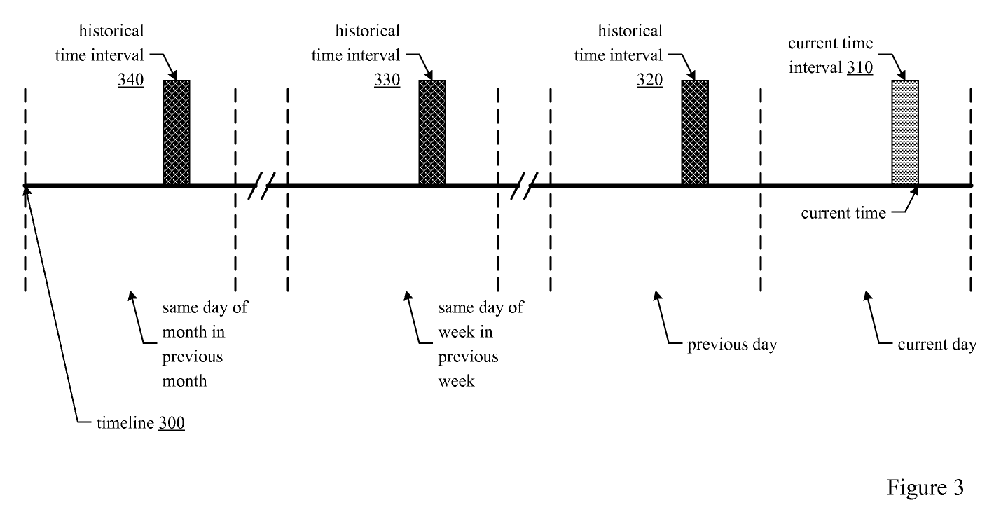

FIG. 3 illustrates an example timeline 300 that ends on the current day. The current time interval 310 is a segment of time, e.g., a few hours, on the current day that ends at the current time. Three historical time intervals 320, 330, and 340 are illustrated on timeline 300. Specifically, historical time interval 320 is the same segment of time as current time interval 310 but on a previous day. Historical time interval 330 is the same segment of time as current time interval 310 on the same day of the week as the current day during a previous day. Historical time interval 340 is the same segment of time as current time interval 310 on the same day of the month as the current day during a previous month.

In particular embodiments, when constructing a current query model or a historical query model, search queries with minor wording variations are considered as different search queries and have their own counts. Two search queries are considered as the same search query only if all the words in both of the search queries match exactly. For example, the search queries “ebay”, “ebya” (a misspelling of the word “ebay”), “ebay auction”, “auction ebay”, “auction on ebay”, and “ebay seller”, although are all related to the website and company “ebay”, are nevertheless considered as different search queries and have their own counts in the histogram because the words in each of the search queries do not match exactly.

In particular embodiments, optionally, information with respect to contents appeared on the Internet are continuously monitored, collected, and stored (step 215). The information may indicate, among others, the titles of the contents and the time the contents appeared at different sites on the Internet. New contents frequently appear on the Internet, especially contents relating to recently-occurred events, such as breaking news. For example, if an earthquake has occurred in Northern California, during the hours and perhaps days following the earthquake, many news stories concerning the earthquake may appear on the Internet. Each news story may have a title, e.g., the headline. Furthermore, some of the Internet users may repost the same contents at different sites, such that, for example, the same news article may be posted at hundreds of websites around the world.

In particular embodiments, optionally, based on the content information, a current content model and one or more historical content models may be constructed (step 225). In particular embodiments, each content may be identified by its title. Consequently, the current content model represents a histogram of the titles of the individual contents appeared on the Internet during a current time interval and may include, for each content title appeared on the Internet during the current time interval, the total number of times that content title appears on the Internet during the current time interval. Each of the historical query models represents a different histogram of the titles of the individual contents appeared on the Internet during a different historical time interval and may include, for each content title appeared on the Internet during a particular historical time interval, the total number of times that content title appears on the Internet during the historical time interval.

In particular embodiments, the current content model and the historical content models are constructed similarly as the current query model and the historical query models. The difference between a content model and a query model is that the content model represents a histogram of the different content titles appeared on the Internet during a particular time interval and the query model represents a histogram of the different search queries received at a search engine during a particular time interval.

In particular embodiments, when constructing a current content model or a historical content model, content titles with minor wording variations are considered as different content titles and have their own counts. Two content titles are considered as the same content title only if all the words in both of the content titles match exactly. For example, the content titles “Obama Seeks To Trim 2010 Budget By $17 Billion”, “Obama Seeks To Trim 2010 Budget”, “President Obama Seeks To Trim 2010 Budget By $17 Billion”, and “Obama Orders $17 Billion in Budget Cuts”, although are all related to presidential decisions on the U.S. budget, are nevertheless considered as different content titles and have their own counts in the histogram because the words in each of the content titles do not match exactly.

In particular embodiments, the same current time interval may be used for both the current query mode and the current content model. Similarly, the same historical time intervals may be used for both the historical query models and the historical content models. In other words, for the current time interval, there is a corresponding current query model and a corresponding current content model. For each of the historical time intervals, there is a corresponding historical query model and a corresponding historical content model.

The search engine may continuously receive search queries and the contents may continuously appear on the Internet. As time moves forward, the current time also moves forward accordingly. For example, if the current time interval is defined as the most recent three hours prior to the current time, then at 13:00 on May 6, 2009, the current time interval is between 10:00 and 13:00. However, an hour later at 14:00, the current time becomes 14:00 and the current time interval is between 11:00 and 14:00. The historical time intervals may also change with the current time interval. For example, if one of the historical time intervals is defined as the same hours of the day as the current time interval but during a previous day, then when the current time interval is between 10:00 and 13:00 on May 6, 2009, the historical time interval is between 10:00 and 13:00 on May 5, 2009. When the current time interval moves to between 11:00 and 14:00 on May 6, 2009, the historical time interval also moves to between 11:00 and 14:00 on May 5, 2009.

In particular embodiments, the current query model and the historical query model, and optionally, the current content model and the historical query model may be updated from time to time as time moves forward and new information becomes available. For example, the models may be updated once every half hour or once every hour. The actual minutes and hours covered by the current and historical time intervals change as the current time changes. The histograms of the search queries and the content titles may be recalculated using the collected data corresponding to the actual minutes and hours presently covered by the time intervals represented by the models. For example, when the current time interval moves to between 11:00 and 14:00 on May 6, 2009, the histogram of the search queries received at the search engine between 11:00 and 14:00 may be recalculated as the current query model, and the histogram of the content titles appeared on the Internet between 11:00 and 14:00 may be recalculated as the current content model. Same calculations may be employed to update the historical query models and the historical content models.

Once the current query model and the historical query models and optionally the current content model and the historical content models are constructed, they may be used to detect emerging search queries among all the search queries received at a search engine. Again, since the query models and optionally the content models are continuously updated, in particular embodiments, the most-recent current and historical query and content models available are used to detect emerging search queries at any given time.

Upon receiving a search query at the search engine (step 230), to determine whether this search query is an emerging search query, in particular embodiments, a different generation probability is calculated for the search query with respect to the current query model and each of the historical query models, and optionally with respect to the current content model and each of the historical content models (step 240). In general, a generation probability for the search query with respect to a query or content model indicates the probability that the search query may be generated from the segments of the search queries or content titles, i.e., one or more words contained in the search queries or content titles, represented in the query or content model respectively.

Each search query or content title contains one or more words. A segment contained in a search query or content title is one or more consecutive words selected from the search query or content title. For example, if a search query has four words, denoted by w₁, w₂, w₃, and w₄, then a segment of the search query may be any one of the four words, e.g., w₁, w₂, w₃, or w₄, any two consecutive words, e.g., w₁w₂, w₂w₃, or w₃w₄, any three consecutive words, e.g., w₁w₂w₃ or w₂w₃w₄, or all four words, e.g., w₁w₂w₃w₄. For a search query having one or more words, its generation probability is the likelihood that the words of the search query may be generated from the various word segments found in all of the search queries in a query model or all of the content titles in a content model.

Within the context of the present disclosure, let q denote the search query to be evaluated. Let P_{currentQ}(q) denote the generation probability calculated for q with respect to the current query model, and P_{currentC}(q) denote the generation probability calculated for q with respect to the current content model. Suppose that there are a total of m historical query models and a total of m historical content models, with m representing an integer and m≧1. Let P_{historicalQ}_{ᵢ}(q) denote the generation probability calculated for q with respect to a particular historical query model, and P_{historicalC}_{ᵢ}(q) denote the generation probability calculated for q with respect to a particular historical content model.

In particular embodiments, in general, a generation probability for the search query with respect to a query or content model may be calculated using standard statistical language modeling techniques. A search query or a content title may include one or more words. For example, suppose that the search query, q, has two words, denoted by w₁ and w₂, with w₁ being immediately followed by w₂. For this particular q and with respect to the current query model, using a bigram language model with a maximum-likelihood estimate, the generation probability may be calculated as:

$$\begin{matrix}{P}_{currentQ} ( q ) = {P}_{currentQ} ( {w}_{1} ) \cdot {P}_{currentQ} ( {w}_{2} \vert {w}_{1} ) \\ = \frac{{count}_{currentQ} ( {w}_{1} )}{{count}_{currentQ}} \cdot \frac{{count}_{currentQ} ( {w}_{1} {w}_{2} )}{{count}_{currentQ} ( {w}_{1}^{*} )}\end{matrix} \qquad ( 1 )$$

In particular embodiments, the language model may further be smoothed using a standard approach such as lower-ngram interpolation or Witten-Bell smoothing to produce a more accurate generation probability.

In Equation (1), P_{currentQ}(w₁) denotes the probability that w₁ may be generated from the search queries contained in the current query model; count_{currentQ}(w₁) denotes the total number of times of the search queries that actually contains w₁ appeared in the current query model; and count_{currentQ} denotes the total number of times of all of the search queries appeared in the current query model. The conditional probability P_{currentQ}(w₂|w₁) denotes the probability that w₁ being immediately followed by w₂ may be generated from the search queries contained in the current query model; count_{currentQ}(w₁w₂) denotes the total number of times of the search queries that actually contains w₁ and w₂ with w₁ being immediately followed by w₂ appeared in the current query model; and count_{currentQ}(w₁*) denotes the total number of times of the search queries that actually contains w₁ followed by any word appeared in the current query model.

Equation (1) may be generalized for search queries containing any number of words. In general, for a search query, q, having n words, denoted by w₁ . . . wₙ, with n representing an integer and n≧1 and wⱼ denoting a particular one of the words, its generation probability with respect to the current query model may be calculated as:

P_{currentQ}(q)=P_{currentQ}(w₁)·P_{currentQ}(w₂|w₁)·P_{currentQ}(w₃|w₁w₂)· . . . ·P_{currentQ}(wₙ|w₁w₂ . . . wₙ₋₁) (2)

Again, P_{currentQ}(w₁) denotes the probability that w₁ may be generated from the search queries contained in the current query model; P_{currentQ}(w₂|w₁) denotes the conditional probability that w₁ being immediately followed by w₂ may be generated from the search queries contained in the current query model; P_{currentQ}(w₃|w₁w₂) denotes the conditional probability that w₁w₂ being immediately followed by w₃ may be generated from the search queries contained in the current query model; and P_{currentQ}(wₙ|w₁w₂ . . . wₙ₋₁) denotes the conditional probability that w₁w₂ . . . wₙ₋₁ being immediately followed by wₙ may be generated from the first set of search queries contained in the current query model. In particular embodiments, Equation (2) may be approximated using word sequences of length up to m only, rather than the entire query length, using the Markov property as

P_{currentQ}(q)=P_{currentQ}(w₁)·P_{currentQ}(w₂|w₁)·P_{currentQ}(w₃|w₁w₂)· . . . ·P_{currentQ}(wₙ|wₙ₋ₘ₋₁wₙ₋ₘ . . . wₙ₋₁) (3)

Equations (1), (2), and (3) may be similarly applied with respect to the each of the historical query models, the current content model, and each of the historical content models. For a historical query model, the count is with respect to the number of the search queries that satisfy the various criteria in the historical query model. For a current content model or a historical content model, the count is with respect to the number of the content titles that satisfy the various criteria in the current content model or the historical model.

For example, when applying Equation (1) to the current content model, P_{currentQ}(w₁) denotes the probability that w₁ may be generated from the content titles contained in the current content model; count_{currentQ}(w₁) denotes the total number of times of the content titles that actually contains w₁ appeared in the current content model; and count_{currentQ} denotes the total number of times of all of the content titles appeared in the current content model. P_{currentQ}(w₂|w₁) denotes the conditional probability that w₁ being immediately followed by w₂ may be generated from the content titles contained in the current content model; count_{currentQ}(w₁w₂) denotes the total number of times of the content titles that actually contains w₁ and w₂ with w₁ being immediately followed by w₂ appeared in the current content model; and count_{currentQ}(w₁*) denotes the total number of times of the content titles that actually contains w₁ following by any word or words in the current content model.

To further explain Equation (1), consider the following example query model illustrated in Table 2. Note that a small number of search queries and small counts for the individual search queries are used to simplify the discussion. In practice, a query or content model often contains many search queries or content titles.

TABLE 2
Example Search Queries and Their Counts

| Search Queries | Counts |
|---|---|
| w₁ w₄ | 5 |
| w₄ w₅ w₆ | 3 |
| w₄ w₁ w₂ | 10 |
| w₁ w₂ w₃ | 4 |
| w₃ w₄ w₁ w₇ | 8 |
| w₄ w₆ w₁ | 2 |

For the search query, q, having two words, w₁ and w₂, and with respect to the example current query model illustrated in Table 2, count_{currentQ}(w₁)=5+10+4+8+2=29, count_{currentQ}=5+3+10+4+8+2=32, count_{currentQ}(w₁w₂)=10+4=14, and count_{currentQ}(w₁*)=5+10+4+8=27.

Equations (1), (2), and (3) are one way to calculate a generation probability for a query with respect to a particular model. Other suitable statistical language modeling techniques may be used for different embodiments of the present disclosure.

Once the generation probabilities for the search query with respect to the current and historical query models and optionally with respect to the current and historical content models are calculated, a ratio for the search query may be calculated based on the generation probabilities with respect to the current and historical query models and optionally further based on the current and historical content models (step 250).

In particular embodiments, between the current query model and the historical query models, a different intermediate query ratio is calculated between the current query model and each of the historical query models. The ratio between the generation likelihood of two models indicates which model the query is more likely to be associated with. If there are a total of m historical query models, then there are a total of m intermediate query ratios. Within the context of the present disclosure, let r_{Q}_{ᵢ}(q) denote a particular intermediate query ratios between P_{currentQ}(q) and a particular P_{historicalQ}_{ᵢ}(q), calculated as

$${r}_{{Q}_{i}} ( q ) = \frac{{P}_{currentQ} ( q )}{{P}_{{historicalQ}_{i}} ( q )} \qquad ( 3 a )$$

In particular embodiments, optionally, between the current content model and the historical content models, a different intermediate content ratio is calculated between the current content model and each of the historical content models. If there are a total of m historical content models, then there are a total of m intermediate content ratios. Within the context of the present disclosure, let r_{C}_{ᵢ}(q) denotes a particular intermediate content ratios between P_{currentC}(q) and a particular P_{historicalC}_{ᵢ} (q), calculated as

$${r}_{{C}_{i}} ( q ) = \frac{{P}_{currentC} ( q )}{{P}_{{historcalC}_{i}} ( q )} \qquad ( 3 b )$$

In particular embodiments, the final ratio is determined based on the intermediate query ratios and optionally further based on the intermediate content ratios. For example, if only the query models are used, i.e., only the intermediate query ratios being available, the final ratio may be the maximum, the minimum, the average, or any other suitable selection or combination of the intermediate query ratios. If both the query models and the content models are used, i.e., both the intermediate query ratios and the intermediate content ratios being available, the final ratio may be the respective combination of the maximum, the minimum, the average, or any other suitable selection or combination of the intermediate query ratios and the maximum, the minimum, the average, or any other suitable selection or combination of the intermediate content ratios. Within the context of the present disclosure, let R(q) denote the final ratio calculated for q.

For example, the final ratio may be the sum of the average of the intermediate query ratios and the average of the intermediate content ratios, calculate as

$$R ( q ) = \frac{{\sum }_{i = 1}^{i = m} [ {r}_{{Q}_{i}} ( q ) + {r}_{{C}_{i}} ( q ) ]}{m} \qquad ( 3 c )$$

Whether the search query, q, is an emerging search query may be determined based on its final ratio, R(q). In particular embodiments, if the final ratio of a search query satisfies a threshold requirement, e.g., greater than a predetermined threshold value, the search query is considered an emerging search query (step 260). The final ratio may also indicate the confidence level that the search query is an emerging search query. For example, if the maximum or the average of the intermediate ratios is used as the final ratio, then the relatively greater the final ratio value, the relatively more confident that the corresponding search query is an emerging search query.

As indicated above, the current and historical content models are optional for the calculation of the final ratio for a search query. In particular embodiments, only the current and historical query models are used.

As described above, once an emerging search query is identified, the search engine may provide special services in connection with the search result generated in response to the emerging search query.

The method described above may be implemented as computer software using computer-readable instructions and physically stored in computer-readable medium. A “computer-readable medium” as used herein may be any medium that can contain, store, communicate, propagate, or transport the program for use by or in connection with the instruction execution system, apparatus, system or device. The computer readable medium may be, by way of example only but not by limitation, an electronic, magnetic, optical, electromagnetic, infrared, or semiconductor system, apparatus, system, device, propagation medium, or computer memory.

The computer software may be encoded using any suitable computer languages, including future programming languages. Different programming techniques can be employed, such as, for example, procedural or object oriented. The software instructions may be executed on various types of computers, including single or multiple processor devices.

Embodiments of the present disclosure may be implemented by using a programmed general purpose digital computer, by using application specific integrated circuits, programmable logic devices, field programmable gate arrays, optical, chemical, biological, quantum or nano-engineered systems, components and mechanisms may be used. In general, the functions of the present disclosure can be achieved by any means as is known in the art. Distributed, or networked systems, components and circuits can be used. Communication, or transfer, of data may be wired, wireless, or by any other means.

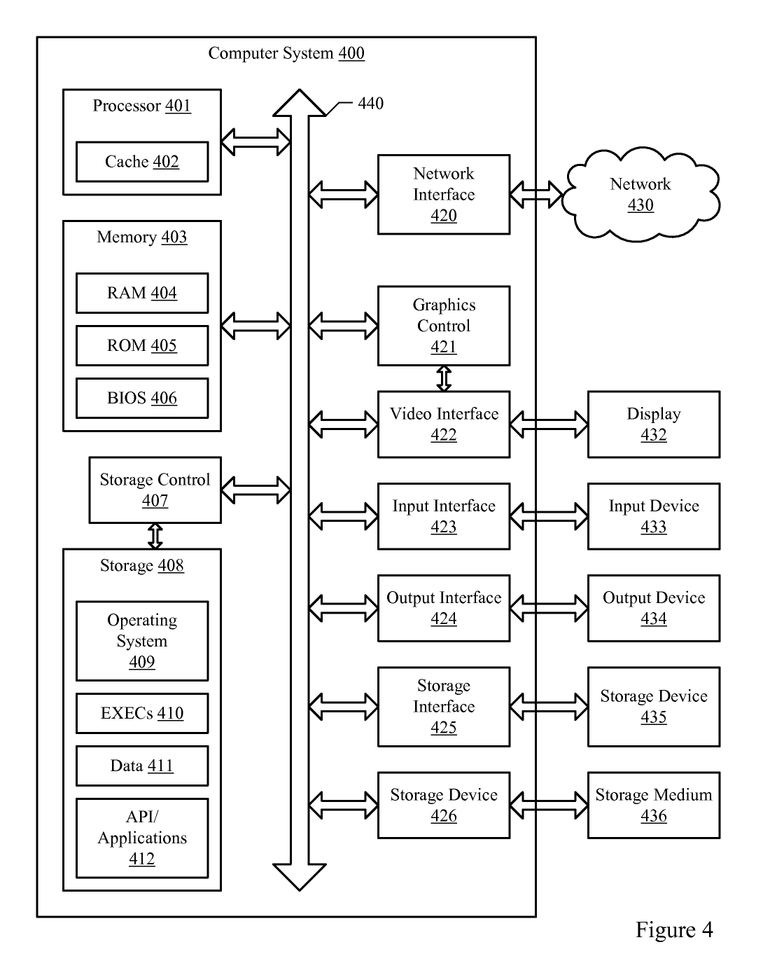

For example, FIG. 4 illustrates a computer system 400 suitable for implementing embodiments of the present disclosure. The components shown in FIG. 4 for computer system 400 are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system. Computer system 400 may have many physical forms including an integrated circuit, a printed circuit board, a small handheld device (such as a mobile telephone or PDA), a personal computer or a super computer.

Computer system 400 includes a display 432, one or more input devices 433 (e.g., keypad, keyboard, mouse, stylus, etc.), one or more output devices 434 (e.g., speaker), one or more storage devices 435, various types of storage medium 436.

The system bus 440 link a wide variety of subsystems. As understood by those skilled in the art, a “bus” refers to a plurality of digital signal lines serving a common function. The system bus 440 may be any of several types of bus structures including a memory bus, a peripheral bus, and a local bus using any of a variety of bus architectures. By way of example and not limitation, such architectures include the Industry Standard Architecture (ISA) bus, Enhanced ISA (EISA) bus, the Micro Channel Architecture (MCA) bus, the Video Electronics Standards Association local (VLB) bus, the Peripheral Component Interconnect (PCI) bus, the PCI-Express bus (PCI-X), and the Accelerated Graphics Port (AGP) bus.

Processor(s) 401 (also referred to as central processing units, or CPUs) optionally contain a cache memory unit 402 for temporary local storage of instructions, data, or computer addresses. Processor(s) 401 are coupled to storage devices including memory 403. Memory 403 includes random access memory (RAM) 404 and read-only memory (ROM) 405. As is well known in the art, ROM 405 acts to transfer data and instructions uni-directionally to the processor(s) 401, and RAM 404 is used typically to transfer data and instructions in a bi-directional manner. Both of these types of memories may include any suitable of the computer-readable media described below.

A fixed storage 408 is also coupled bi-directionally to the processor(s) 401, optionally via a storage control unit 407. It provides additional data storage capacity and may also include any of the computer-readable media described below. Storage 408 may be used to store operating system 409, EXECs 410, application programs 412, data 411 and the like and is typically a secondary storage medium (such as a hard disk) that is slower than primary storage. It should be appreciated that the information retained within storage 408, may, in appropriate cases, be incorporated in standard fashion as virtual memory in memory 403.

Processor(s) 401 is also coupled to a variety of interfaces such as graphics control 421, video interface 422, input interface 423, output interface, storage interface, and these interfaces in turn are coupled to the appropriate devices. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, or other computers. Processor(s) 401 may be coupled to another computer or telecommunications network 430 using network interface 420. With such a network interface 420, it is contemplated that the CPU 401 might receive information from the network 430, or might output information to the network in the course of performing the above-described method steps. Furthermore, method embodiments of the present disclosure may execute solely upon CPU 401 or may execute over a network 430 such as the Internet in conjunction with a remote CPU 401 that shares a portion of the processing.

According to various embodiments, when in a network environment, i.e., when computer system 400 is connected to network 430, computer system 400 may communicate with other devices that are also connected to network 430. Communications may be sent to and from computer system 400 via network interface 420. For example, incoming communications, such as a request or a response from another device, in the form of one or more packets, may be received from network 430 at network interface 420 and stored in selected sections in memory 403 for processing. Outgoing communications, such as a request or a response to another device, again in the form of one or more packets, may also be stored in selected sections in memory 403 and sent out to network 430 at network interface 420. Processor(s) 401 may access these communication packets stored in memory 403 for processing.

In addition, embodiments of the present disclosure further relate to computer storage products with a computer-readable medium that have computer code thereon for performing various computer-implemented operations. The media and computer code may be those specially designed and constructed for the purposes of the present disclosure, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher-level code that are executed by a computer using an interpreter.

As an example and not by way of limitation, the computer system having architecture 400 may provide functionality as a result of processor(s) 401 executing software embodied in one or more tangible, computer-readable media, such as memory 403. The software implementing various embodiments of the present disclosure may be stored in memory 403 and executed by processor(s) 401. A computer-readable medium may include one or more memory devices, according to particular needs. Memory 403 may read the software from one or more other computer-readable media, such as mass storage device(s) 435 or from one or more other sources via communication interface. The software may cause processor(s) 401 to execute particular processes or particular steps of particular processes described herein, including defining data structures stored in memory 403 and modifying such data structures according to the processes defined by the software. In addition or as an alternative, the computer system may provide functionality as a result of logic hardwired or otherwise embodied in a circuit, which may operate in place of or together with software to execute particular processes or particular steps of particular processes described herein. Reference to software may encompass logic, and vice versa, where appropriate. Reference to a computer-readable media may encompass a circuit (such as an integrated circuit (IC)) storing software for execution, a circuit embodying logic for execution, or both, where appropriate. The present disclosure encompasses any suitable combination of hardware and software.

A “processor”, “process”, or “act” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time”, “offline”, in a “batch mode”, etc. Portions of processing can be performed at different times and at different locations, by different (or the same) processing systems.

Although the acts, operations or computations disclosed herein may be presented in a specific order, this order may be changed in different embodiments. In addition, the various acts disclosed herein may be repeated one or more times using any suitable order. In some embodiments, multiple acts described as sequential in this disclosure can be performed at the same time. The sequence of operations described herein can be interrupted, suspended, or otherwise controlled by another process, such as an operating system, kernel, etc. The acts can operate in an operating system environment or as stand-alone routines occupying all, or a substantial part, of the system processing.

Reference throughout the present disclosure to “particular embodiment”, “example embodiment”, “illustrated embodiment”, “some embodiments”, “various embodiments”, “one embodiment”, or “an embodiment” means that a particular feature, structure, or characteristic described in connection with the embodiment is included in at least one embodiment of the present disclosure and not necessarily in all embodiments. Thus, respective appearances of the phrases “in a particular embodiment”, “in one embodiment”, “in some embodiments”, or “in various embodiments” in various places throughout this specification are not necessarily referring to the same embodiment. Furthermore, the particular features, structures, or characteristics of any specific embodiment of the present disclosure may be combined in any suitable manner with one or more other embodiments. It is to be understood that other variations and modifications of the embodiments of the present disclosure described and illustrated herein are possible in light of the teachings herein and are to be considered as part of the spirit and scope of the present disclosure.

It will also be appreciated that one or more of the elements depicted in FIGS. 1 through 4 can also be implemented in a more separated or integrated manner, or even removed or rendered as inoperable in certain cases, as is useful in accordance with a particular application.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise. Additionally, the term “or” as used herein is generally intended to mean “and/or” unless otherwise indicated. Combinations of components or steps will also be considered as being noted, where terminology is foreseen as rendering the ability to separate or combine is unclear.

While this disclosure has described several preferred embodiments, there are alterations, permutations, and various substitute equivalents, which fall within the scope of this disclosure. It should also be noted that there are many alternative ways of implementing the methods and apparatuses of the present disclosure. It is therefore intended that the following appended claims be interpreted as including all such alterations, permutations, and various substitute equivalents as fall within the true spirit and scope of the present disclosure.

What is claimed is:

1. A method, comprising:
constructing by one or more computer systems a current query model representing a first histogram of a first set of counts corresponding to a first set of search queries received at a search engine during a current time interval;
constructing one or more historical query models, each of the historical query models uniquely representing a different one of one or more second histograms of a different one of one or more second sets of counts corresponding to a different one of one or more second sets of search queries received at the search engine during a different one of one or more historical time intervals;
receiving a third search query at the search engine;
calculating a first generation probability for the third search query with respect to the current query model, the first generation probability representing a likelihood that the third search query is generated from the first set of search queries as represented in the current query model;
calculating one or more second generation probabilities for the third search query with respect to the historical query models, each of the second generation probabilities being uniquely calculated with respect to a different one of the historical query models and representing a likelihood that the third search query is generated from the corresponding second set of search queries as represented in the corresponding historical query model;
calculating a ratio based on the first generation probability and the second generation probabilities; and
identifying the third search query as corresponding to an emerging event if the ratio satisfies a predetermined threshold requirement.

2. The method as recited in claim 1, wherein the ratio indicates a confidence level that the third search query is an emerging search query.

3. The method as recited in claim 1, wherein the first generation probability and each of the second generation probability are calculated using a statistical language modeling technique.

4. The method as recited in claim 3, wherein the first generation probability is calculated as:
P_{currentQ}(q)=P_{currentQ}(w₁)·P_{currentQ}(w₂|w₁)·P_{currentQ}(w₃|w₁w₂)· . . . ·P_{currentQ}(wₙ|w₁w₂ . . . wₙ₋₁)
where:
q denotes the third search query having n words, denoted by w₁ . . . wₙ,
n denotes an integer and n≧1,
P_{currentQ}(w₁) denotes the probability that w₁ may be generated from the first set of search queries contained in the current query model,
P_{currentQ}(w₂|w₁) denotes the conditional probability that w₁ being immediately followed by w₂ may be generated from the first set of search queries contained in the current query model,
P_{currentQ}(w₃|w₁w₂) denotes the conditional probability that w₁w₂ being immediately followed by w₃ may be generated from the first set of search queries contained in the current query model, and
P_{currentQ}(wₙ|w₁w₂ . . . wₙ₋₁) denotes the conditional probability that w₁w₂ . . . wₙ₋₁ being immediately followed by wₙ may be generated from the first set of search queries contained in the current query model.

5. The method as recited in claim 1, wherein calculating the ratio based on the first generation probability and the second generation probabilities comprises:
calculating one or more intermediate ratios, each of the intermediate ratios being between the first generation probability and a different one of the second generation probabilities; and
calculating the ratio based on the intermediate ratios.

6. The method as recited in claim 5, wherein the ratio is a maximum of the intermediate ratios, a minimum of the intermediate ratios, or an average of the intermediate ratios.

7. The method as recited in claim 1, further comprising:
constructing a current content model representing a third histogram of a third set of counts corresponding to a first set of content titles appeared on the Internet during the current time interval;
constructing one or more historical content models, each of the historical content models representing a different one of one or more fourth histograms of a different one of one or more fourth sets of counts corresponding to a different one of one or more second sets of content titles appeared on the Internet during a different one of the historical time intervals;
calculating a third generation probability for the third search query with respect to the current content model, the third generation probability representing a likelihood that the third search query is generated from the first set of content titles as represented in the current content model; and
calculating one or more fourth generation probabilities for the third search query with respect to the historical content models, each of the fourth generation probabilities being uniquely calculated with respect to a different one of the historical content models and representing a likelihood that the third search query is generated from the corresponding second set of content titles as represented in the corresponding historical content model,
wherein the ratio is calculated further based on the third generation probability and the fourth generation probabilities.

8. The method as recited in claim 7, wherein calculating the ratio based on the first generation probability, the second generation probabilities, the third generation probability, and the fourth generation probabilities comprises:
calculating one or more first intermediate ratios, each of the first intermediate ratios being between the first generation probability and a different one of the second generation probabilities;
calculating one or more second intermediate ratios, each of the second intermediate ratios being between the third generation probability and a different one of the fourth generation probabilities; and
calculating the ratio based on the first intermediate ratios and the second intermediate ratios.

9. The method as recited in claim 8, wherein the ratio is a combination of a maximum of the first intermediate ratios and a maximum of the second intermediate ratios, a combination of a minimum of the first intermediate ratios and a minimum of the second intermediate ratios, or a combination of an average of the first intermediate ratios and an average of the second intermediate ratios.

10. The method as recited in claim 7, further comprising:
continuously monitoring search queries received at the search engine;
continuously monitoring content titles appeared on the Internet;
from time to time updating the current query model and the historical query models based on the search queries most-recently received at the search engine and a current time; and
from time to time updating the current content model and the historical content models based on the content titles most-recently appeared on the Internet and the current time.

11. The method as recited in claim 1, further comprising:
continuously monitoring search queries received at the search engine; and
from time to time updating the current query model and the historical query models based on the search queries most-recently received at the search engine and a current time.

12. The method as recited in claim 1, wherein the current time interval is a predetermined interval of time ending at a current time.

13. The method as recited in claim 12, wherein each of the historical time interval is an interval of time similar to the current time interval but from a different day.

14. The method as recited in claim 1, further comprising:
generating a search result by the search engine in response to the third search query, the search result identifying one or more contents relevant to the search query; and
if the third search query is identified, then providing time information with each of the contents when presenting the search result to a user requesting the third search query.

15. The method as recited in claim 14, further comprising:
if the third search query is identified, then ranking the contents using a first ranking algorithm; and
if the third search query is not identified, then ranking the contents using a second ranking algorithm.

16. An apparatus comprising:
a memory comprising instructions executable by one or more processors; and
one or more processors coupled to the memory and operable to execute the instructions, the one or more processors being operable when executing the instructions to:
construct a current query model representing a first histogram of a first set of counts corresponding to a first set of search queries received at a search engine during a current time interval;
construct one or more historical query models, each of the historical query models uniquely representing a different one of one or more second histograms of a different one of one or more second sets of counts corresponding to a different one of one or more second sets of search queries received at the search engine during a different one of one or more historical time intervals;
receive a third search query at the search engine;
calculate a first generation probability for the third search query with respect to the current query model, the first generation probability representing a likelihood that the third search query is generated from the first set of search queries as represented in the current query model;
calculate one or more second generation probabilities for the third search query with respect to the historical query models, each of the second generation probabilities being uniquely calculated with respect to a different one of the historical query models and representing a likelihood that the third search query is generated from the corresponding second set of search queries as represented in the corresponding historical query model;
calculate a ratio based on the first generation probability and the second generation probabilities; and
identify the third search query as corresponding to an emerging event if the ratio satisfies a predetermined threshold requirement.

17. The apparatus as recited in claim 16, wherein:
the ratio indicates a confidence level that the third search query is an emerging search query, and
to calculate the ratio based on the first generation probability and the second generation probabilities comprises:
calculate one or more intermediate ratios, each of the intermediate ratios being between the first generation probability and a different one of the second generation probabilities; and
calculate the ratio based on the intermediate ratios.

18. The apparatus as recited in claim 16, wherein the first generation probability and each of the second generation probability are calculated using a statistical language modeling technique.

19. The apparatus as recited in claim 18, wherein the first generation probability is calculated as:
P_{currentQ}(q)=P_{currentQ}(w₁)·P_{currentQ}(w₂|w₁)·P_{currentQ}(w₃|w₁w₂)· . . . ·P_{currentQ}(wₙ|w₁w₂ . . . wₙ₋₁)
where:
q denotes the third search query having n words, denoted by w₁ . . . wₙ
n denotes an integer and n≧1,
P_{currentQ}(w₁) denotes the probability that w₁ may be generated from the first set of search queries contained in the current query model,
P_{currentQ}(w₂|w₁) denotes the conditional probability that w₁ being immediately followed by w₂ may be generated from the first set of search queries contained in the current query model,
P_{currentQ}(w₃|w₁w₂) denotes the conditional probability that w₁w₂ being immediately followed by w₃ may be generated from the first set of search queries contained in the current query model, and
P_{currentQ}(wₙ|w₁w₂ . . . wₙ₋₁) denotes the conditional probability that w₁w₂ . . . wₙ₋₁ being immediately followed by wₙ may be generated from the first set of search queries contained in the current query model.

20. The apparatus as recited in claim 16, wherein the one or more processors are further operable when executing the instructions to:
construct a current content model representing a third histogram of a third set of counts corresponding to a first set of content titles appeared on the Internet during the current time interval;
construct one or more historical content models, each of the historical content models representing a different one of one or more fourth histograms of a different one of one or more fourth sets of counts corresponding to a different one of one or more second sets of content titles appeared on the Internet during a different one of the historical time intervals;
calculate a third generation probability for the third search query with respect to the current content model, the third generation probability representing a likelihood that the third search query is generated from the first set of content titles as represented in the current content model; and
calculate one or more fourth generation probabilities for the third search query with respect to the historical content models, each of the fourth generation probabilities being uniquely calculated with respect to a different one of the historical content models and representing a likelihood that the third search query is generated from the corresponding second set of content titles as represented in the corresponding historical content model,
wherein the ratio is calculated further based on the third generation probability and the fourth generation probabilities.

21. The apparatus as recited in claim 20, wherein to calculate the ratio based on the first generation probability, the second generation probabilities, the third generation probability, and the fourth generation probabilities, the one or more processors are further operable when executing the instructions to:
calculate one or more first intermediate ratios, each of the first intermediate ratios being between the first generation probability and a different one of the second generation probabilities;
calculate one or more second intermediate ratios, each of the second intermediate ratios being between the third generation probability and a different one of the fourth generation probabilities; and
calculate the ratio based on the first intermediate ratios and the second intermediate ratios.

22. The apparatus as recited in claim 16, wherein the one or more processors are further operable when executing the instructions to:
generate a search result by the search engine in response to the third search query, the search result identifying one or more contents relevant to the search query; and
if the third search query is identified, then:
provide time information with each of the contents when presenting the search result to a user requesting the third search query; and
rank the contents using a first ranking algorithm; and
if the third search query is not identified, then rank the contents using a second ranking algorithm.

23. One or more computer-readable storage media embodying software operable when executed by one or more computer systems to:
construct a current query model representing a first histogram of a first set of counts corresponding to a first set of search queries received at a search engine during a current time interval;
construct one or more historical query models, each of the historical query models uniquely representing a different one of one or more second histograms of a different one of one or more second sets of counts corresponding to a different one of one or more second sets of search queries received at the search engine during a different one of one or more historical time intervals;
receive a third search query at the search engine;
calculate a first generation probability for the third search query with respect to the current query model, the first generation probability representing a likelihood that the third search query is generated from the first set of search queries as represented in the current query model;
calculate one or more second generation probabilities for the third search query with respect to the historical query models, each of the second generation probabilities being uniquely calculated with respect to a different one of the historical query models and representing a likelihood that the third search query is generated from the corresponding second set of search queries as represented in the corresponding historical query model;
calculate a ratio based on the first generation probability and the second generation probabilities; and
identify the third search query as corresponding to an emerging event if the ratio satisfies a predetermined threshold requirement.

24. The media as recited in claim 23, wherein:
the ratio indicates a confidence level that the third search query is an emerging search query, and
to calculate the ratio based on the first generation probability and the second generation probabilities comprises:
calculate one or more intermediate ratios, each of the intermediate ratios being between the first generation probability and a different one of the second generation probabilities; and
calculate the ratio based on the intermediate ratios.

25. The media as recited in claim 23, wherein the first generation probability and each of the second generation probability are calculated using a statistical language modeling technique.

26. The media as recited in claim 25, wherein the first generation probability is calculated as:
P_{currentQ}(q)=P_{currentQ}(w₁)·P_{currentQ}(w₂|w₁)·P_{currentQ}(w₃|w₁w₂)· . . . ·P_{currentQ}(wₙ|w₁w₂ . . . wₙ₋₁)
where:
q denotes the third search query having n words, denoted by w₁ . . . wₙ,
n denotes an integer and n≧1,
P_{currentQ}(w₁) denotes the probability that w₁ may be generated from the first set of search queries contained in the current query model,
P_{currentQ}(w₂|w₁) denotes the conditional probability that w₁ being immediately followed by w₂ may be generated from the first set of search queries contained in the current query model,
P_{currentQ}(w₃|w₁w₂) denotes the conditional probability that w₁w₂ being immediately followed by w₃ may be generated from the first set of search queries contained in the current query model, and
P_{currentQ} (wₙ|w₁w₂ . . . wₙ₋₁) denotes the conditional probability that w₁w₂ . . . wₙ₋₁ being immediately followed by wₙ may be generated from the first set of search queries contained in the current query model.

27. The media as recited in claim 23, wherein the software is further operable when executed by the one or more computer systems to:
construct a current content model representing a third histogram of a third set of counts corresponding to a first set of content titles appeared on the Internet during the current time interval;
construct one or more historical content models, each of the historical content models representing a different one of one or more fourth histograms of a different one of one or more fourth sets of counts corresponding to a different one of one or more second sets of content titles appeared on the Internet during a different one of the historical time intervals;
calculate a third generation probability for the third search query with respect to the current content model, the third generation probability representing a likelihood that the third search query is generated from the first set of content titles as represented in the current content model; and
calculate one or more fourth generation probabilities for the third search query with respect to the historical content models, each of the fourth generation probabilities being uniquely calculated with respect to a different one of the historical content models and representing a likelihood that the third search query is generated from the corresponding second set of content titles as represented in the corresponding historical content model,
wherein the ratio is calculated further based on the third generation probability and the fourth generation probabilities.

28. The media as recited in claim 27, wherein to calculate the ratio based on the first generation probability, the second generation probabilities, the third generation probability, and the fourth generation probabilities, the software is further operable when executed by the one or more computer systems to:
calculate one or more first intermediate ratios, each of the first intermediate ratios being between the first generation probability and a different one of the second generation probabilities;
calculate one or more second intermediate ratios, each of the second intermediate ratios being between the third generation probability and a different one of the fourth generation probabilities; and
calculate the ratio based on the first intermediate ratios and the second intermediate ratios.

29. The media as recited in claim 23, wherein the software is further operable when executed by the one or more computer systems to:
generate a search result by the search engine in response to the third search query, the search result identifying one or more contents relevant to the search query; and
if the third search query is identified, then:
provide time information with each of the contents when presenting the search result to a user requesting the third search query; and
rank the contents using a first ranking algorithm; and
if the third search query is not identified, then rank the contents using a second ranking algorithm.
